(19) United States
(12) Patent Application Publication
(10) Pub. No.: US 2025/0065791 A1
(43) Pub. Date: Feb. 27, 2025

(54) Vehicle Seat Recliner Mechanism With Encapsulating Ring

(71) Applicant: Fisher & Company, Incorporated, St. Clair Shores, MI (US)

(72) Inventors: Ralph L. SCHMITZ, Clinton Township, MI (US); Sapan M. POPTANI, Northville, MI (US)

(73) Assignee: Fisher & Company, Incorporated, St. Clair Shores, MI (US)

(21) Appl. No.: 18/755,989

(22) Filed: Jun. 27, 2024

Related U.S. Application Data
(60) Provisional application No. 63/533,820, filed on Aug. 21, 2023.

(51) Int. Cl. B60N 2/90; B60N 2/20

(52) U.S. Cl. CPC B60N 2/933; B60N 2/20

(57) ABSTRACT

A recliner heart may include a first locking plate, a second locking plate, a hub, an encapsulating plate, and a spacer ring. The first locking plate includes an outer diametrical surface having first teeth formed thereon. The second locking plate is rotatable relative to the first locking plate and includes an inner diametrical surface having second teeth formed thereon. Some of the second teeth are meshingly engaged with some of the first teeth. The hub extends through the first and second locking plates. The encapsulating ring extends annularly about the first and second locking plates and is not pressed into the first locking plate. The spacer ring is disposed axially between the second locking plate and the encapsulating ring and radially between the hub and the encapsulating ring.

### CROSS-REFERENCE TO RELATED APPLICATIONS

This application claims the benefit of U.S. Provisional Application No. 63/533,820, filed on Aug. 21, 2023. The entire disclosure of the above application is incorporated herein by reference.

### FIELD

The present disclosure relates to a recliner mechanism for a vehicle seat assembly, and more particularly, to a recliner mechanism with an encapsulating ring.

### BACKGROUND

This section provides background information related to the present disclosure and is not necessarily prior art.

Vehicle seats often include a recliner heart that can selectively rotate a seatback relative to a seat bottom. The recliner heart is operable between a locked position in which the seatback is prevented from being rotated relative to the seat bottom, and an unlocked position in which the seatback is allowed to rotate relative to the seat bottom. The recliner heart includes a plurality of components that must be positioned in a precise location and spaced apart from each other at a precise clearance. However, moving one or more of the components to achieve the precise clearance is often difficult. The present disclosure provides a recliner heart having an encapsulating ring in a slip fit arrangement such that the encapsulating ring can be easily moved to achieve the precise clearance to surrounding components.

### SUMMARY

This section provides a general summary of the disclosure and is not a comprehensive disclosure of its full scope or all of its features.

In one form, the present disclosure provides a recliner heart that may include a first locking plate, a second locking plate, a hub, an encapsulating ring, and a spacer ring. The first locking plate includes an outer diametrical surface having first teeth formed thereon. The second locking plate is rotatable relative to the first locking plate and includes an inner diametrical surface having second teeth formed thereon. Some of the second teeth are meshingly engaged with some of the first teeth. The hub extends through the first and second locking plates. The encapsulating ring extends annularly about the first and second locking plates and is not pressed into the first locking plate. The spacer ring is disposed axially between the second locking plate and the encapsulating ring and radially between the hub and the encapsulating ring.

In some configurations of the recliner heart of the above paragraph, the spacer ring has a central aperture extending through the spacer ring and a body extending annularly about the central aperture.

In some configurations of the recliner heart of any one or more of the above paragraphs, the body has a thickness measured between a first surface and a second surface of the spacer ring, wherein the thickness is uniform along the body.

In some configurations of the recliner heart of any one or more of the above paragraphs, the first surface of the spacer ring is positioned adjacent to a lip of the encapsulating ring and the second surface of the spacer ring is positioned adjacent to a rim of the second locking plate.

In some configurations of the recliner heart of any one or more of the above paragraphs, the second surface of the spacer ring is spaced from the rim of the second locking plate.

In some configurations of the recliner heart of any one or more of the above paragraphs, the encapsulating ring includes a body that includes a first end and a second end, a lip that extends radially inwardly from the first end of the body, and a flange that extends radially outwardly from the second end of the body.

In some configurations of the recliner heart of any one or more of the above paragraphs, the lip of the encapsulating ring abuts the spacer ring.

In some configurations of the recliner heart of any one or more of the above paragraphs, the body of the encapsulating ring has an inner radial surface that is spaced from an outer radial surface of the first locking plate.

In some configurations of the recliner heart of any one or more of the above paragraphs, the first locking plate has a rim that is positioned radially outwardly from the first teeth and extends annularly about the first teeth.

In some configurations of the recliner heart of any one or more of the above paragraphs, the rim of the first locking plate has an outer radial surface that is spaced from an inner radial surface of the encapsulating ring.

In another form, the present disclosure provides a recliner heart that may include a first locking plate, a second locking plate, an encapsulating ring, and a spacer ring. The second locking plate is rotatable relative to the first locking plate. The hub extends through the first locking plate and is configured to rotate to position the recliner heart in a locked state and in an unlocked state. The encapsulating ring extends annularly about the first and second locking plates and not pressed into the first locking plate. The spacer ring is disposed axially between the second locking plate and the encapsulating ring and radially between the hub and the encapsulating ring.

In some configurations of the recliner heart of the above paragraph, the spacer ring is positioned adjacent to the encapsulating ring and spaced from a rim of the second locking plate.

In some configurations of the recliner heart of any one or more of the above paragraphs, the encapsulating ring includes a body and a lip that extends radially inwardly from one end of the body.

In some configurations of the recliner heart of any one or more of the above paragraphs, the body of the encapsulating ring has an inner radial surface that is spaced from an outer radial surface of the first locking plate.

In some configurations of the recliner heart of any one or more of the above paragraphs, the first locking plate has a rim that is positioned radially outwardly from the second locking plate.

In some configurations of the recliner heart of any one or more of the above paragraphs, the rim of the first locking plate has an outer radial surface that is spaced from an inner radial surface of the encapsulating ring.

In another form, the present disclosure provides a method for manufacturing a recliner heart. The method may include positioning a first locking plate of the recliner heart relative to a second locking plate of the recliner heart, slip fitting an encapsulating ring onto the first locking plate such that the first and second locking plates are received in the encapsulating ring and the encapsulating ring extends around the first and second locking plates, setting a gap between the encapsulating ring and the second locking plate after the encapsulating ring is slip fitted onto the first locking plate, and fixedly attaching the first locking plate to the encapsulating ring after setting the gap.

In some configurations of the method of the above paragraph, the encapsulating ring is slip fitted onto the first locking plate such that the encapsulating ring is radially spaced from an outer radial surface of the first locking plate.

In some configurations of the method of any one or more of the above paragraphs, the method may further include positioning a spacer ring between the encapsulating ring and the second locking plate.

In some configurations of the method of any one or more of the above paragraphs, the spacer ring is positioned such that the spacer ring is axially spaced from the second locking plate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a partial perspective view of a vehicle having a seat incorporating a recliner assembly according to the principles of the present disclosure;

FIG. 2 is a perspective view of the recliner assembly shown in FIG. 1;

FIG. 3 is a perspective view of one recliner heart of the recliner assembly shown in FIG. 1;

FIG. 4 is another perspective view of one recliner heart of the recliner assembly shown in FIG. 1;

FIG. 5 is an exploded view of the recliner heart shown in FIGS. 3-4;

FIG. 6 is another exploded view of the recliner heart;

FIG. 7 is a cross-sectional view of the recliner heart;

FIG. 8 is a partial cross-sectional view of the recliner heart; and

FIG. 9 is a flow chart of a method of manufacturing the recliner heart.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

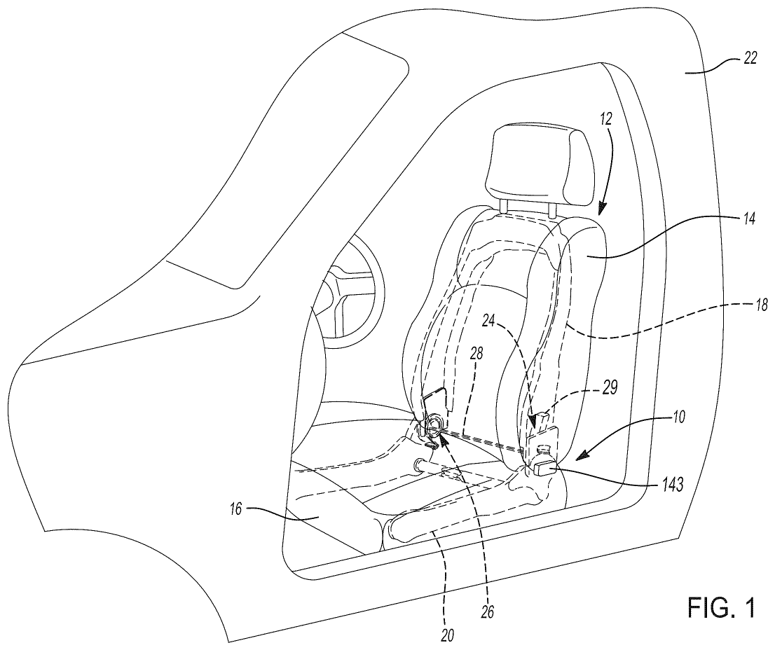

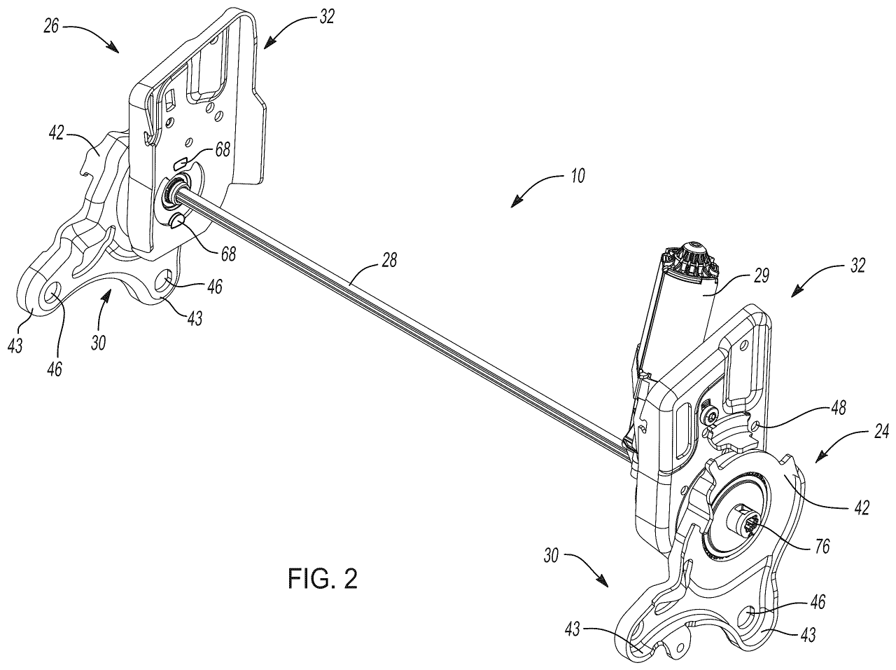

With reference to FIGS. 1 and 2, a recliner assembly 10 is provided that may be incorporated into a vehicle seat assembly 12 having a seatback 14 and a seat bottom 16. The seatback 14 and seat bottom 16 may include a seatback frame 18 and a seat bottom frame 20, respectively. The seat assembly 12 may be positioned in a vehicle 22, as shown in FIG. 1. The recliner assembly 10 may include a first recliner mechanism 24, a second recliner mechanism 26, a cross member 28, and a motor 29. The first and second recliner mechanisms 24, 26 may be operable in a locked state preventing relative rotation between the seatback 14 and the seat bottom 16 and an unlocked state permitting relative rotation between the seatback 14 and the seat bottom 16 among an upright position (FIG. 1), a rearward reclined position (not shown) and a forward dump position (not shown).

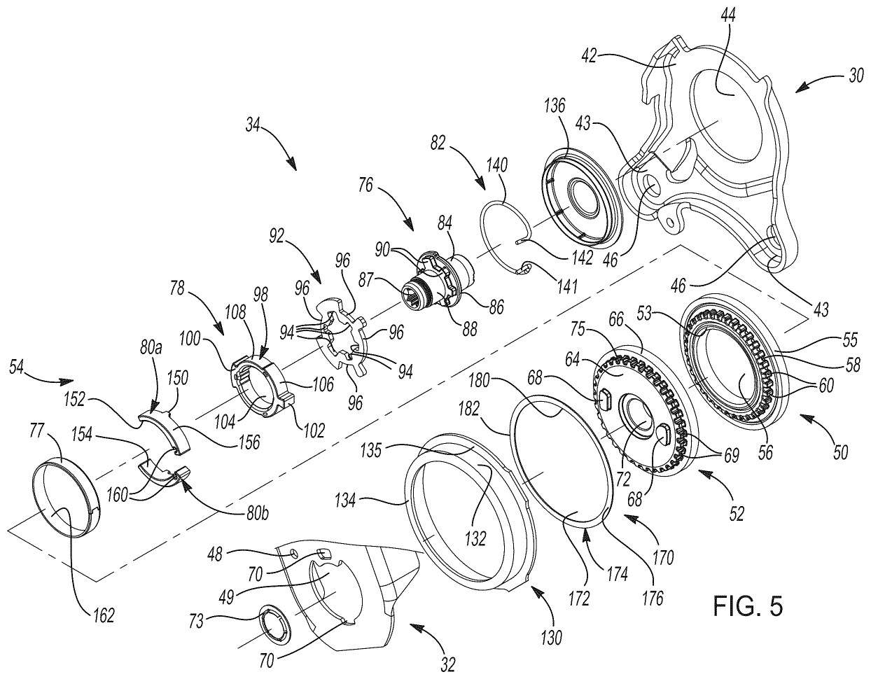

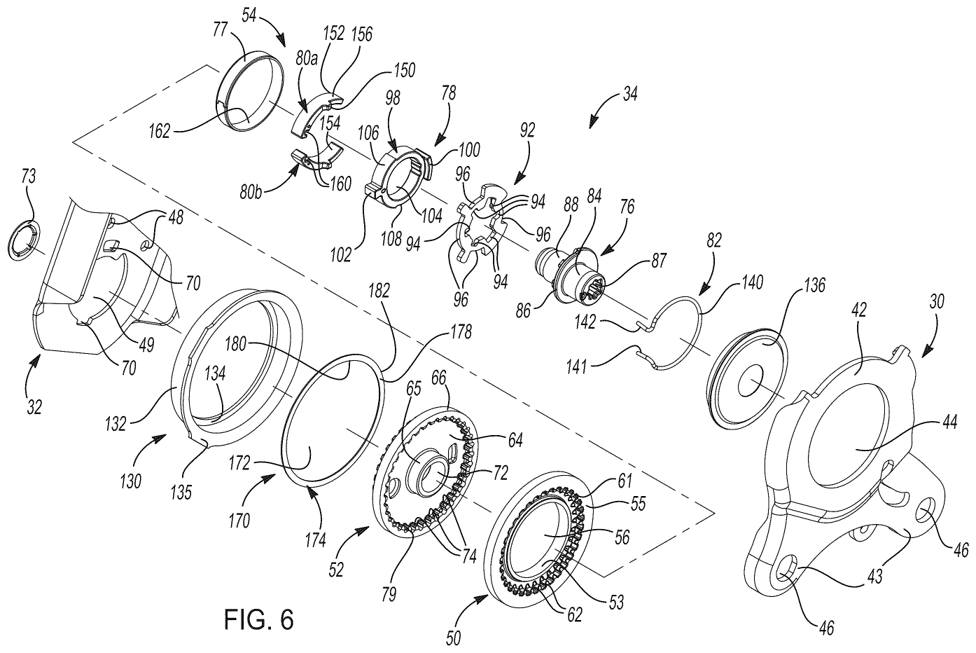

With reference to FIGS. 2-6, the first recliner mechanism 24 may include a first bracket 30, a second bracket 32 and a recliner heart (or locking mechanism) 34. The first bracket 30 may include a generally round main body 42 and a pair of mounting lobes 43 that extend outward from the main body 42. The main body 42 may define a central aperture 44 (FIGS. 5-6). The mounting lobes 43 may include a plurality of apertures 46 through which fasteners (not shown) may extend to securely attach the first bracket 30 to the seat bottom frame 20 of the seat assembly 12 (FIG. 1).

The second bracket 32 may be generally rectangular and may include a plurality of apertures 48, and a central aperture 49 (FIGS. 5 and 6) through which the cross member 28 extends. Fasteners (not shown) may extend through the plurality of apertures 48 to securely attach the second bracket 32 to the seatback frame 18 of the seat assembly 12 (FIG. 1).

The recliner heart 34 may be mounted to the first and second brackets 30, 32 and may selectively permit relative rotation between the seatback 14 and the seat bottom 16. The recliner heart 34 may be a round recliner heart, for example, or any other suitable type of recliner heart. The recliner heart 34 may include a first locking plate 50, a second locking plate 52 and a locking assembly 54.

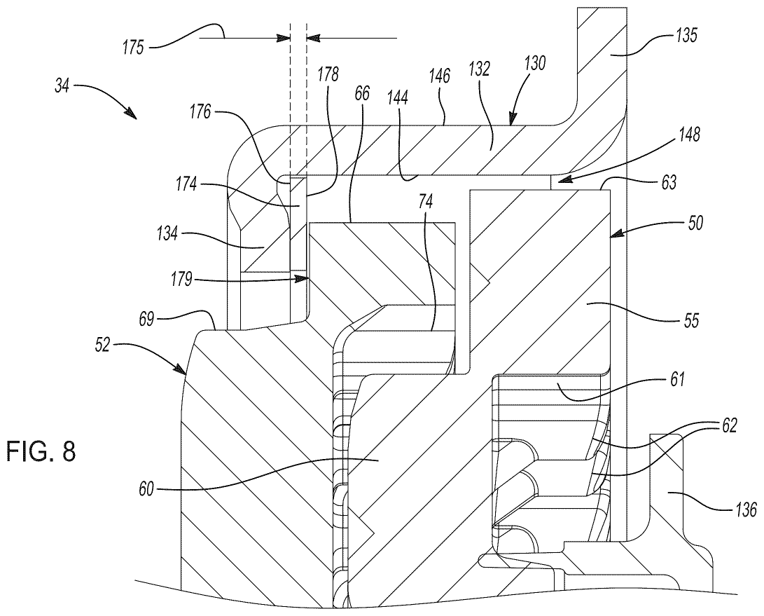

With referenced to FIGS. 5-6, the first locking plate 50 may be rotationally fixed to the first bracket 30 and may have a generally circular shape. The first locking plate 50 may include an inner section 53 and a rim or outer section 55. The inner section 53 may define an opening 56 and may include an outer diametrical surface 58 having teeth 60 thereon. The rim 55 may be rotationally fixed to the first bracket 30 and may extend 360 degrees around a periphery of the inner section 53. In other words, the rim 55 may be positioned radially outwardly from the teeth 60 and may extend annularly about the teeth 60. The rim 55 may include an inner diametrical surface 61 having teeth 62 thereon and an outer diametrical surface 63 (FIG. 8) that is opposite to the inner diametrical surface 61.

The second locking plate 52 may have a generally circular shape and may include a plate body 64, a hub 65 and a rim 66. The plate body 64 may include projections 68, teeth 69, and a seat 71 (FIG. 5). The projections 68 may extend from a surface of the plate body 64 and may be received in respective openings 70 of the second bracket 32, thereby rotationally fixing the second locking plate 52 with the second bracket 32 and the seatback 14 (FIG. 1). The teeth 69 may extend 360 degrees around an outer diametrical surface 75 of the plate body 64. The seat 71 may be positioned at a center portion of the plate body 64. A retaining ring 73 may be seated in the seat 71. The hub 65 (FIG. 6) may extend from the center portion of the plate body 64 in a direction opposite of the projections 68 and from a surface opposite of the seat 71. The hub 65 may define an opening 72 extending therethrough. The rim 66 may extend 360 degrees around a periphery of the plate body 64 and may include teeth 74 (FIG. 6) that extend 360 degrees around an inner diametrical surface 79 of the rim 66.

The locking assembly 54 may include a hub 76, a bushing ring 77, a cam 78, a pair of wedges 80a, 80b and a spring or biasing member 82. The hub 76 may include a hub portion 84, a flange portion 86 and a shaft portion 88. The flange portion 86 may extend radially outward relative to the hub portion 84 and shaft portion 88. The shaft portion 88 may extend axially from one side of the flange portion 86 and the hub portion 84 may extend axially from the other side of the flange portion 86. The shaft portion 88 may extend through the cam 78, the bushing ring 77, the opening 56 of the first locking plate 50 and the opening 72 of the hub 65 of the second locking plate 52. The shaft portion 88 may include a plurality of radially extending protrusions 90. The cross member 28 (FIGS. 1 and 2) may be received in an aperture 87 of the hub 76 such that the hub 76 is drivingly engaged with the cross member 28. In this way, rotation of the cross member 28 causes corresponding rotation of the hub 76.

A transfer plate 92 may be disposed between the flange portion 86 of the hub 76 and the cam 78. The transfer plate 92 may include a plurality of first rectangular-shaped slots 94 and a plurality of second rectangular-shaped slots 96. Each protrusion 90 of the hub 76 may be received in a respective first slot 94, thereby rotationally fixing the transfer plate 92 to the hub 76. The bushing ring 77 may be pressed-fitted into the opening 56 of the first locking plate 50 and between the inner section 53 of the first locking plate 50 and the cam 78.

The cam 78 may be disposed around the hub 65 of the second locking plate 52. The cam 78 may include a body 98, an attachment portion 100 and a distal portion 102. The body 98 may be circular in shape and may define an aperture 104 that receives the hub 65 of the second locking plate 52. The body 98 may have a first portion 106 and a second portion 108. The first portion 106 may have a thickness that is greater than a thickness of the second portion 108 of the body 98.

The attachment portion 100 may be rectangular-shaped and may be integral with an outer surface of the second portion 108 of the body 98. The attachment portion 100 may include an end that extends through one of the second slots 96 of the transfer plate 92 such that the cam 78 and the hub 76 are rotationally fixed to each other. The distal portion 102 may be integral with an outer surface of the first portion 106 such that it is 180 degrees opposite the attachment portion 100.

The wedges 80a, 80b are disposed between the body 98 of the cam 78 and the bushing ring 77. Each wedge 80a, 80b has a first end 150 and a second end 152. The first end 150 extends into a respective second slot 96 of the transfer plate 92. Each wedge 80a, 80b also has a curved inner surface 154 and a curved outer surface 156. The inner surface 154 may contact the first portion 106 of the body 98 and may include a groove 160 formed therein. The groove 160 receives the spring 82 such that the spring 82 forces the wedges 80a, 80b outwardly and away from the distal portion 102 of the cam 78. The outer surface 156 may contact an inside surface 162 of the bushing ring 77.

The spring 82 includes a curved (or arc shaped) body 140, a first leg 141, and a second leg 142. The body 140 extends at least partially around flange portion 86 of the hub 76. The first leg 141 extends from a first end of the body 140 and the second leg 142 extends from a second end of the body 140. The first and second legs 141, 142 extend through a respective second rectangular-shaped slot 96 of the transfer plate 92 and are received in the grooves 160 of the wedges 80a, 80b, respectively.

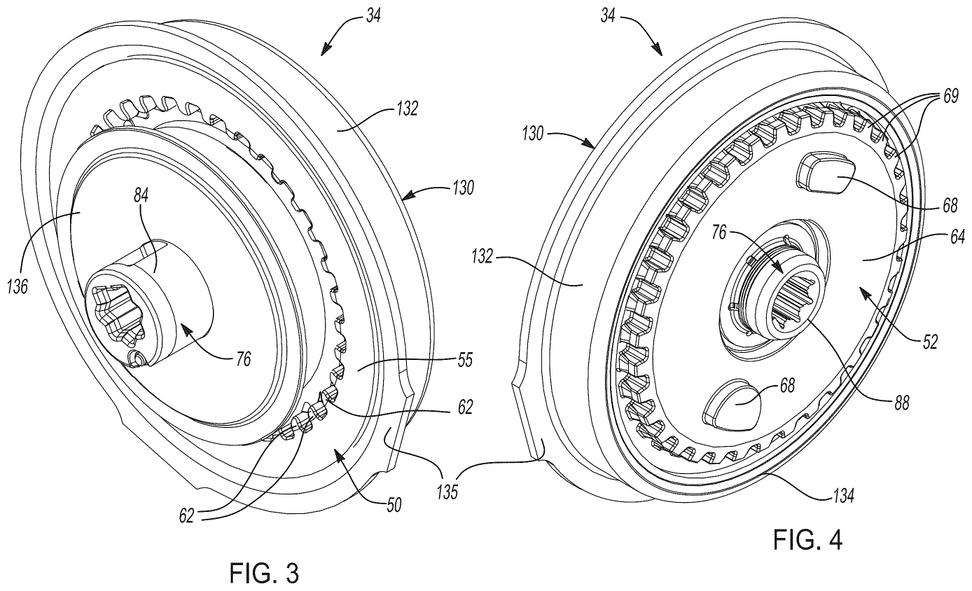

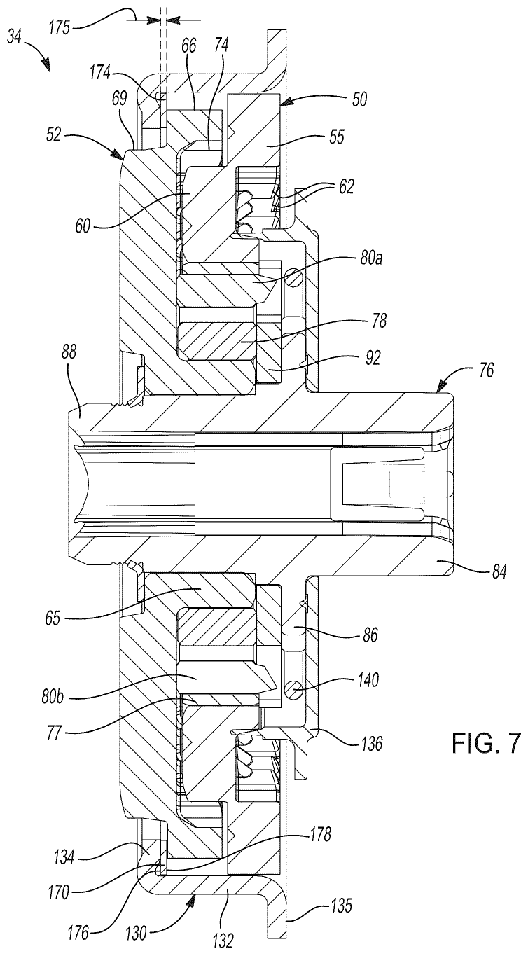

With reference to FIGS. 3-8, an encapsulating ring 130 may extend annularly around the first and second locking plates 50, 52. During assembly of the recliner heart 34, the encapsulating ring 130 may be slip fitted onto the first locking plate 50 and subsequently secured (e.g., welded) to the first locking plate 50. The encapsulating ring 130 may not be press fitted onto the second locking plate 50. The encapsulating ring 130 may include a body 132, a lip 134 that extends radially inwardly from a first axial end of the body 132, and a flange 135 that extends radially outwardly from a second axial end of the body 132. The body 132 may be attached (e.g., by laser welding) to the first locking plate 50 to hold the recliner heart 34 together and also to cover a periphery of the recliner heart 34, thereby preventing debris and fluid from infiltrating and damaging the recliner heart 34. The body 132 may include an inner radial surface 144 and an outer radial surface 146. The inner radial surface 144 may be spaced from the outer diametrical surface 63 (FIG. 8) of the rim 55 of the first locking plate 50. In other words, a gap 148 may be formed between the inner radial surface 144 of the encapsulating ring 130 and the outer radial surface of the first locking plate 50. A circular-shaped cap 136 may be attached (e.g., laser welding) to the flange portion 86 of the hub 76 and may cover the recliner heart 34, thereby preventing debris and fluid from infiltrating and damaging the recliner heart 34.

A spacer ring 170 may be disposed between the second locking plate 52 and the encapsulating ring 130. More specifically, the spacer ring 170 may be positioned between the rim 66 of the second locking plate 52 and the lip 134 of the encapsulating ring 130. The spacer ring 170 is permanent. In other words, the spacer ring 170 is not burned, melted or otherwise discarded of. The spacer ring 170 may have a central aperture 172 and a body 174. The central aperture 172 may extend axially through the spacer ring 170. The body 174 may extend annularly about the central aperture 172. The body 174 may have a first surface 176 (FIG. 5) and a second surface 178 (FIG. 6). The body 174 may have a thickness 175 measured between the first and second surfaces 176, 178. The thickness 175 may be uniform along the body 174. The first surface 176 may abut the lip 134 of the encapsulating ring 130. The first surface 176 may be sealingly engaged with the lip 134 of the encapsulating ring 130, thereby preventing debris and fluid from infiltrating and damaging the recliner heart 34. The second surface 178 may be positioned adjacent to the rim 66 of the second locking plate 52. A gap 179 may be provided axially between the second surface 178 of the spacer ring 170 and the rim 66 of the second locking plate 52. For example, in some embodiments, the gap 179 may range from about 0.05 millimeters (mm) to about 0.25 mm. The body 174 may have an inner radial end 180 and an outer radial end 182. The inner radial end 180 may be aligned with an end of the lip 134 of the encapsulating ring 130. The inner radial end 180 may be radially spaced from the teeth 69 of the second locking plate 52 during movement of the second locking plate 52. The outer radial end 182 may be axially spaced from the body 132 of the encapsulating ring 130. The spacer ring 170 may be made of a plastic material, a metal material, or another suitable material.

The structure and function of the second recliner mechanism 26 may be similar or identical to that of the first recliner mechanism 24, and therefore, will not be described again in detail.

With reference to FIGS. 1-8, operation of the recliner assembly 10 will be described in detail. Prior to actuating an actuation switch 143 (shown schematically in FIG. 1) that controls the motor 29 of the seat assembly 12, the spring 82 force the wedges 80a, 80b outwardly such that the wedges 80a, 80b are wedged between the first portion 106 of the body 98 of the cam 78 and the bushing ring 77. In this way, the first and second recliner mechanisms 24, 26 are in the locked state thereby preventing relative rotation between the seatback 14 and the seat bottom 16.

When a user actuates the actuation switch 143, the motor 29 drives the cross member 28, which causes the hub 76 to rotate. Rotation of the hub 76 in the clockwise direction (viewed when facing the hub portion 84 of the hub 76) causes the transfer plate 92, the cam 78 and the wedges 80a, 80b to rotate relative to the first locking plate 50 and the bushing ring 77. Rotation of the hub 76, the transfer plate 92, the cam 78 and the wedges 80a, 80b causes rotation of the second locking plate 52 relative to the first locking plate 50 and the bushing ring 77 in an oscillating pattern. In this way, a portion of the teeth 74 of the second locking plate 52 are meshingly engaged with a portion of the teeth 60 of the first locking plate 50 at different points in the rotational path as the second locking plate 52 rotates about the first locking plate 50, thereby rotating the seatback 14.

The positioning of the encapsulating ring 130 relative to the second locking plate 52 allows the recliner heart 34 to achieve a predetermined torsional friction between the second locking plate 52 and the first locking plate 50 (i.e., friction between the locking plates 50, 52 that resists relative rotation between the locking plates 50, 52). An encapsulating ring that is pressed into the second locking plate 52 would result in a torsional friction that exceeds the predetermined torsional friction and inhibit oscillating movement of the second locking plate 52. Similarly, an encapsulating ring that is spaced apart from the second locking plate 52 greater than a predetermined distance would result in a torsional friction that is less than the predetermined torsional friction and may cause the second locking plate 52 to disengage from the first locking plate 50. Thus, precise positioning of the encapsulating ring 130 achieves the predetermined torsional friction for a smooth oscillating pattern movement of the second locking plate 52 relative to the first locking plate 50.

The encapsulating ring 130 is arranged in a slip fit configuration relative to the first locking plate 50. The slip fit configuration allows the encapsulating ring to freely move relative to the first locking plate 50. Accordingly, the slip fit configuration allows for a more efficient achievement of the gap 179 axially between the spacer ring 170 and the second locking plate 52, and thereby more efficient achievement of the predetermined torsional friction. Advantageously, the slip fit arrangement of the encapsulating ring 130 allows for the encapsulating ring 130 to be able to move in small increments to achieve the gap 179 more efficiently, as compared to when the encapsulating ring 130 is arranged in a press fit configuration. Subsequently to achieving the gap 179, the encapsulating ring 130 is secured (e.g., welded) to the first locking plate 50.

To achieve the slip fit arrangement of the encapsulating ring 130, the spacer ring 170 is provided. The spacer ring 170 allows for the encapsulating ring 130 to be spaced apart from second locking plate 52. Additionally, the spacer ring 170 provides support to the second locking plate 52 and assists in preventing winking between the second locking plate 52 and the encapsulating ring 130 during the oscillating movement of the second locking plate 52 relative to the first locking plate 50.

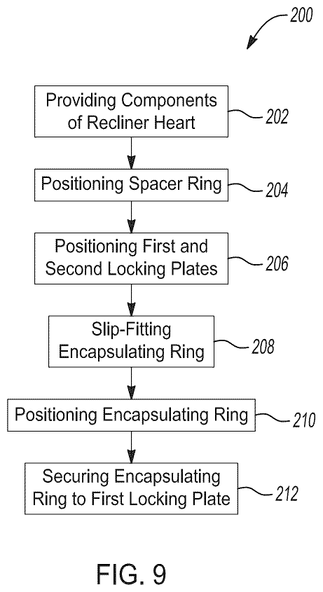

FIG. 9 illustrates a method 200 of manufacturing the recliner heart 34. At 202, the first locking plate 50, the second locking plate 52, the hub 76, the bushing ring 77, the cam 78, the wedges 80a, 80b, the spring 82, the transfer plate 92, the encapsulating ring 130, and the spacer ring 170 of the recliner heart 34 may be provided. At 204, the spacer ring 170 may be positioned relative to the encapsulating ring 130. The spacer ring 170 may be positioned within the encapsulating ring 130. In one example, the spacer ring 170 may be attached to the encapsulating ring 130. In another example, the spacer ring 170 may be loosely received within the encapsulating ring 130.

At 206, the first and second locking plates 50, 52 may be positioned relative to each other. In one example, a fixture may be used to position the first and second locking plates 50, 52. A first arm of the fixture may grasp the first locking plate 50 and a second arm of the fixture may grasp the second locking plate 52. The first arm may position the first locking plate 50 such that the teeth 60 of the first locking plate 50 meshingly engage with the teeth 74 of the second locking plate 52. Additionally, some or all of the hub 76, the bushing ring 77, the cam 78, the wedges 80a, 80b, the spring 82, and the transfer plate 92 may be assembled together.

At 208, the encapsulating ring 130 with the spacer ring 170 may be slip fitted onto the first locking plate 50. The first and second locking plates 50, 52 may be received in the encapsulating ring 130 and the encapsulating ring 130 may extend around the first and second locking plates 50, 52. At 210, the encapsulating ring 130 may be positioned to set the gap 179 after the encapsulating ring 130 is slip fitted onto the first locking plate 50. The encapsulating ring 130 may be easily moved to position the gap 179 because the encapsulating ring 130 is slip-fitted onto the second locking plate 52, as compared to being press-fitted onto the second locking plate 52.

At 212, the encapsulating ring 130 may be secured (i.e., fixedly attached) to the first locking plate 50 after setting the gap 179. One or more tack welds may be disposed between the rim 55 of the first locking plate 50 and the flange 135 of the encapsulating ring 130.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A recliner heart comprising:
a first locking plate including an outer diametrical surface having first teeth formed thereon;
a second locking plate rotatable relative to the first locking plate and including an inner diametrical surface having second teeth formed thereon, wherein some of the second teeth are meshingly engaged with some of the first teeth;
a hub extending through the first and second locking plates;
an encapsulating ring extending annularly about the first and second locking plates and not pressed into the first locking plate; and
a spacer ring disposed axially between the second locking plate and the encapsulating ring and radially between the hub and the encapsulating ring.

2. The recliner heart of claim 1, wherein the spacer ring has a central aperture extending through the spacer ring and a body extending annularly about the central aperture.

3. The recliner heart of claim 2, wherein the body has a thickness measured between a first surface and a second surface of the spacer ring, wherein the thickness is uniform along the body.

4. The recliner heart of claim 3, wherein the first surface of the spacer ring is positioned adjacent to a lip of the encapsulating ring and the second surface of the spacer ring is positioned adjacent to a rim of the second locking plate.

5. The recliner heart of claim 4, wherein the second surface of the spacer ring is spaced from the rim of the second locking plate.

6. The recliner heart of claim 1, wherein the encapsulating ring includes a body that includes a first end and a second end, a lip that extends radially inwardly from the first end of the body, and a flange that extends radially outwardly from the second end of the body.

7. The recliner heart of claim 6, wherein the lip of the encapsulating ring abuts the spacer ring.

8. The recliner heart of claim 6, wherein the body of the encapsulating ring has an inner radial surface that is spaced from an outer radial surface of the first locking plate.

9. The recliner heart of claim 1, wherein the first locking plate has a rim that is positioned radially outwardly from the first teeth and extends annularly about the first teeth.

10. The recliner heart of claim 9, wherein the rim of the first locking plate has an outer radial surface that is spaced from an inner radial surface of the encapsulating ring.

11. A recliner heart comprising:
a first locking plate;
a second locking plate rotatable relative to the first locking plate;
a hub extending through the first locking plate and configured to rotate to position the recliner heart in a locked state and in an unlocked state;
an encapsulating ring extending annularly about the first and second locking plates and not pressed into the first locking plate; and
a spacer ring disposed axially between the second locking plate and the encapsulating ring and radially between the hub and the encapsulating ring.

12. The recliner heart of claim 11, wherein the spacer ring is positioned adjacent to the encapsulating ring and spaced from a rim of the second locking plate.

13. The recliner heart of claim 11, wherein the encapsulating ring includes a body and a lip that extends radially inwardly from one end of the body.

14. The recliner heart of claim 13, wherein the body of the encapsulating ring has an inner radial surface that is spaced from an outer radial surface of the first locking plate.

15. The recliner heart of claim 11, wherein the first locking plate has a rim that is positioned radially outwardly from the second locking plate.

16. The recliner heart of claim 15, wherein the rim of the first locking plate has an outer radial surface that is spaced from an inner radial surface of the encapsulating ring.

17. A method of manufacturing a recliner heart comprising:
positioning a first locking plate of the recliner heart relative to a second locking plate of the recliner heart;
slip fitting an encapsulating ring onto the first locking plate such that the first and second locking plates are received in the encapsulating ring and the encapsulating ring extends around the first and second locking plates;
setting a gap between the encapsulating ring and the second locking plate after the encapsulating ring is slip fitted onto the first locking plate; and
fixedly attaching the first locking plate to the encapsulating ring after setting the gap.

18. The method of claim 17, wherein the encapsulating ring is slip fitted onto the first locking plate such that the encapsulating ring is radially spaced from an outer radial surface of the first locking plate.

19. The method of claim 17, further comprising:
positioning a spacer ring between the encapsulating ring and the second locking plate.

20. The method of claim 19, wherein the spacer ring is positioned such that the spacer ring is axially spaced from the second locking plate.
